(19) United States
(12) Patent Application Publication
(10) Pub. No.: US 2003/0075257 A1
(43) Pub. Date: Apr. 24, 2003

(54) Flexographic printing method

(76) Inventor: Aldo Salvestro, Burnaby (CA)

Correspondence Address: OYEN, WIGGS, GREEN & MUTALA, 480 - THE STATION, 601 WEST CORDOVA STREET, VANCOUVER, BC, V6B 1G1, CA

(21) Appl. No.: 10/271,991

(22) Filed: Oct. 17, 2002

(30) Foreign Application Priority Data
Oct. 18, 2001 (CA) 2,359,259

(51) Int. Cl. B32B 31/00

(52) U.S. Cl. 156/64; 156/277; 156/256

(57) ABSTRACT

Methods and apparatus are provided for improving the accuracy and streamlining the process of preparing a flexographic printing sleeve to be imaged with a printing image to produce a flexographic printing forme. Layout details are determined by a controller and transferred to an automated cutting machine. The controller may also control a printer to print indicia on a sleeve for use in aligning the cut flexographic plate sections.

### CROSS REFERENCE TO RELATED APPLICATION

The benefit of the filing date of Canadian patent application No. 2,359,259 filed on Oct. 18, 2001 is claimed herein.

### TECHNICAL FIELD

This invention relates to flexographic printing, and more specifically to an improved process for preparing flexographic printing sleeves.

### BACKGROUND

Flexographic printing is a method of direct rotary printing that uses resilient relief image plates. The plates are typically made of rubber or photopolymer. Flexographic printing has found particular application in packaging where it has displaced rotogravure and offset lithography printing techniques in many cases. While flexographic printing can produce high quality printed products, making flexographic printing formes according to prior art processes can be undesirably time consuming and labour intensive.

Typical conventional flexographic plates have a flat polyester base coated with a photopolymer layer. The photopolymer layer is sensitive to ultraviolet (UV) radiation, such that it hardens when exposed to UV light. In a first step, a floor is set by exposing the back of the plate to UV light. The floor forms the base of the relief that will be formed in further imaging steps. A film mask, which is imaged in a separate process, is placed over the top of the photopolymer layer, and drawn down by a vacuum frame to ensure good contact. The photopolymer layer is then flood exposed to UV light, thereby hardening or cross-linking the regions of the photopolymer layer not covered by the mask. After the mask is removed, the plate is processed in solvents to form a printing image by removing the unexposed areas of the photopolymer layer which were covered by the mask. After processing with solvents the plate must be dried. Drying may take several hours.

Digital flexography follows a similar process except that the plate has an integral UV-opaque mask layer coated over the photopolymer layer. The mask layer is selectively ablated by a digital imager with a high-power laser imaging head to form an image mask that is opaque to UV light in non-ablated areas. Once the mask is formed, processing of the plate continues as it would for conventional flexographic plates except that there is no need to use a vacuum frame to ensure good contact between the mask and photopolymer layer since the mask layer is integral with the photopolymer layer. Other flexographic plate formulations, such as Cyrel® Fast made by E. I. Dupont de Nemours and Company, eliminate the use of solvents for the processing step and reduce the combined processing and drying time.

The processed flexographic plate is then mounted on a cylinder for use on a flexographic press using an adhesive layer such as a double sided adhesive tape or foam. The imaged plate must be mounted in precise registration on the cylinder. This is done using mechanical and/or electronic aids. Accurate registration is key in producing a high quality printed product. Mounting is typically done by skilled operators.

When a rectangular flexographic plate is mounted on a press cylinder there is a gap or “seam” where the top and bottom of the plate approach one another. On the printing press, the printing stock is backed up by an impression cylinder. The impression cylinder presses the printing stock into contact with the flexographic plate relief mounted on the press cylinder. The impression cylinder sets a contact pressure for the printing operation. As the seam contacts the impression cylinder on each rotation, the discontinuity jolts the impression cylinder slightly, a phenomenon known as “press bounce” or “cylinder bounce”. This jolt puts an upper limit on the impression speed, beyond which registration and other printing errors occur.

A common method of reducing the effects of cylinder bounce is to stagger the seam around the cylinder. This method is particularly effective when a repeated pattern is imaged across the cylinder; a common situation in flexographic printing. The plates are arranged so that the impression cylinder is always contacting a relief image and does not fall into a seam. A staggered seam can be achieved by laying out the image so that several plate sections are applied to the cylinder in what are known as lanes. In FIG. 1-A a number of plate sections 40 have been cut and imaged. In FIG. 1-B the plate sections 40 are shown wrapped around cylinder 32. The seam 42 for the flexographic plate in each lane is offset from the seams of other lanes so that the seams are distributed around the circumference of the cylinder. The impression cylinder no longer falls into a seam since it is always riding on the image relief of one or more lanes.

A staggered seam may also be achieved by cutting the plate seam in a staircase shape. FIG. 1-C shows a photopolymer plate 30 cut with a staircase seam 33. The seam layout has the same repeat as the image elements 31. In FIG. 1-D plate 30 is shown wrapped around cylinder 32. The location of seam 33 is chosen so that the plate completely wraps around the cylinder with the seams precisely lining up.

While a staggered seam is effective in reducing the effects of cylinder bounce, the manual cutting, mounting, and registration of the plates on the press cylinder is both time consuming and lacking in accuracy for high quality imaging.

To avoid registration problems, the mask layer may be imaged after mounting the plate on the cylinder. In this way, the registration is provided by the imaging device, which can place an image very accurately. The UV exposure and processing of a plate imaged while on a cylinder in this manner requires specialized equipment, now commonly available, that can operate on round cylinders rather than flat plates.

In order to make the handling of cylindrical photopolymer plates more convenient, sleeve substrates have been developed. A sleeve substrate typically comprises a cylindrical tube of nickel, polyester or some other material. The sleeve substrate material is chosen to have a certain degree of elasticity so that air pressure can be used to expand the sleeve slightly, thus allowing it to be slid over a cylinder on a cushion of air. Once the air supply is removed, the sleeve substrate shrinks so that it is held tightly in place. A photopolymer plate, referred to herein as a “flexographic printing precursor”, may be mounted on the sleeve substrate using double-sided tape in the same way flat plates are mounted on a cylinder. The cut photopolymer plate is wrapped around the sleeve in approximate registration and then imaged on a digital imager to produce a flexographic printing forme which is ready to be placed on a printing cylinder for use in a flexographic printing operation. This process employing a sleeve substrate as a base for mounting a flat plate is known in the industry as Plate-on-Sleeve (PoS).

FIG. 2 shows a flow diagram of a prior art process for making a typical PoS flexographic printing forme. A flexographic printing precursor 1 comprising a photoplymer layer and a UV opaque mask layer is back exposed in step 2 to set a floor for the relief image. In step 3 the flexographic printing precursor is cut into sections so that it can be applied to a sleeve substrate in lanes to form a staggered seam. The flexographic printing precursor sections are then mounted on a sleeve substrate using double-sided tape in step 4 to produce a flexographic printing sleeve. Registration of the flexographic printing precursor sections must be accurate enough to ensure that the image will not run into a seam, but since the flexographic printing sleeve is not yet imaged, the accuracy required is significantly reduced. Alternatively, the flexographic printing precursor could be cut to form a section with a staggered seam as shown in FIG. 1-C and mounted as a single piece to a sleeve substrate in step 4.

Referring again to FIG. 2 image data 7 is typically pre-formatted by one or more computer workstations connected to a network to enable file or data transfer. A packaging workflow system 5 and a controller 6 combine to layout an image including the details of how it will be imaged and printed. These workstations provide functionality enabling an operator to take an image file from a customer and arrange the image for optimal printing.

A digital imager 8 ablates the UV opaque mask layer according to the image data 7. The flexographic printing sleeve is then exposed to UV light in step 9, hardening or cross-linking areas where the UV opaque mask layer has been ablated. A processing step 10 follows. Processing may include washing in solvents, drying, and a final UV exposure to fully harden the photopolymer and remove tackiness. The finished photopolymer printing forme 11 is then ready for printing on a flexographic press.

Digital imaging devices for imaging such flexographic printing sleeves are typically built in the general form of a lathe. Such machines have a mandrel on which a flexographic printing sleeve can be mounted, a fixed headstock for driving the flexographic printing sleeve, a moveable tailstock for supporting the flexographic printing sleeve, and a travelling imaging head. The imaging head typically has a radiation source, such as a laser, capable of imagewise ablating the mask layer.

There is a need for methods for streamlining the making of flexographic printing sleeves. In high quality printing there is a particular need for methods for cutting, handling and mounting sections of flexographic printing precursor on a sleeve substrate in such a way that registration errors are minimised. It is desirable that the overall time required to make a flexographic printing forme be reduced.

### SUMMARY OF INVENTION

A method is provided for automating the cutting of a flexographic printing precursor into sections for application to a sleeve substrate. A controller is operative to provide previously determined layout information to the cutting operation. The controller is also operative to provide layout information to a printing device enabling registration marks to be printed on the sleeve substrate. The printed registration marks aid in the accurate placement of the flexographic printing precursor sections on the sleeve substrate.

A significant advantage of the photopolymer platemaking process outlined herein is that the accuracy of the operation is improved while the time taken in tedious manual operations is reduced. The application of the methods of the present invention will speed up these processes and improve registration accuracy. The possibility of operator error is also reduced.

### BRIEF DESCRIPTION OF DRAWINGS

In drawings which illustrate non-limiting embodiments of the invention:

FIG. 1-A is a depiction of a prior art flat flexographic printing plate cut into lanes;

FIG. 1-B is a depiction of a prior art flexographic printing plate mounted on a printing cylinder in lanes with staggered seams;

FIG. 1-C is a depiction of a prior art flat flexographic printing plate cut with a staircase seam;

FIG. 1-D is a depiction of a prior art flexographic printing plate with a staircase seam wrapped around a printing cylinder;

FIG. 2 is a flowchart illustrating a prior art process for making a flexographic printing forme;

FIG. 3 is a flowchart illustrating an improved method according to this invention;

FIG. 4 is a schematic depiction of apparatus according to the invention;

FIG. 5-A is a depiction of a sleeve substrate with registration marks corresponding to a staggered seam printed thereon; and,

FIG. 5-B is a depiction of a sleeve substrate with registration marks corresponding to a staircase seam printed thereon.

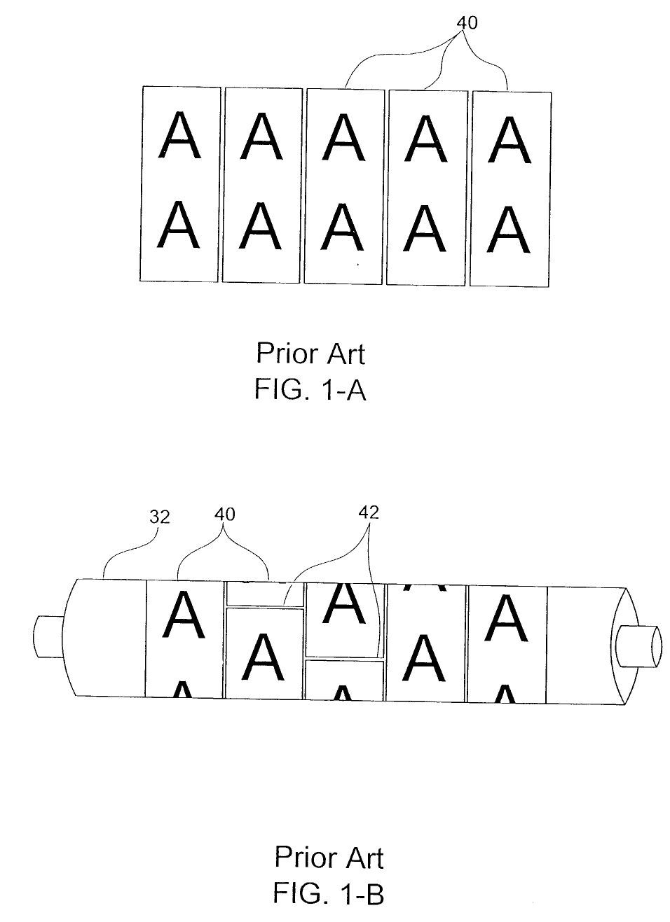

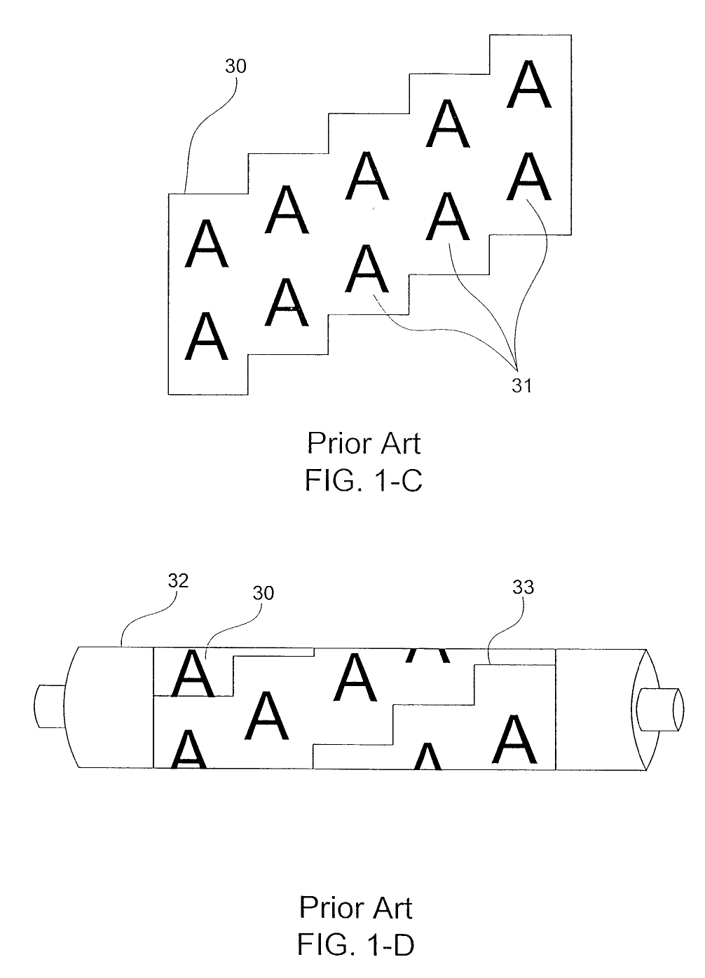

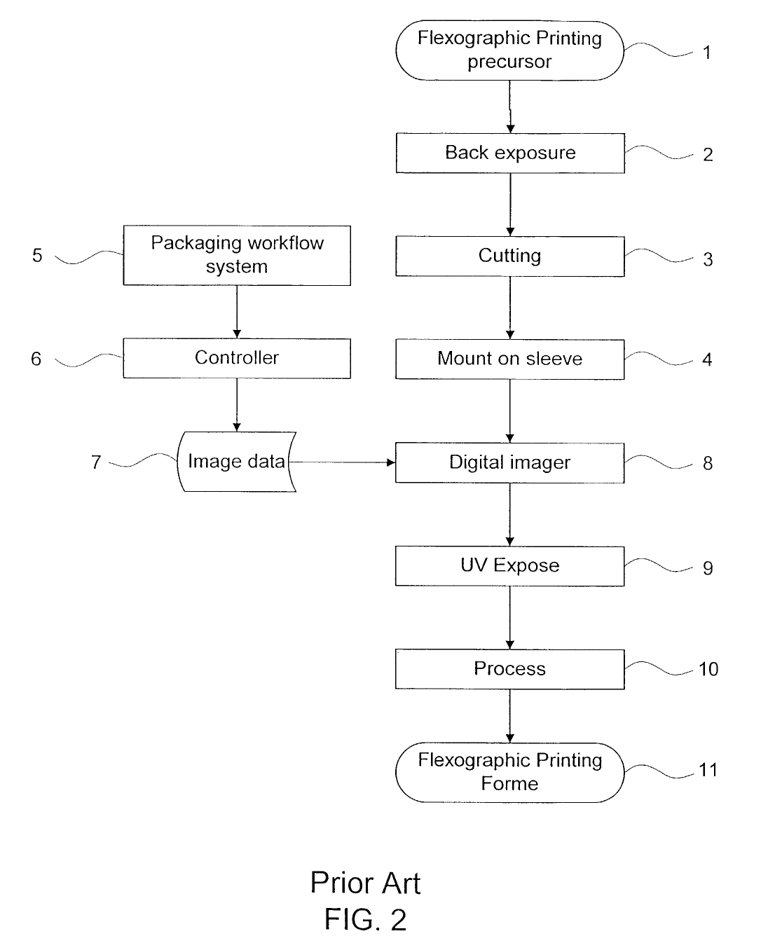

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

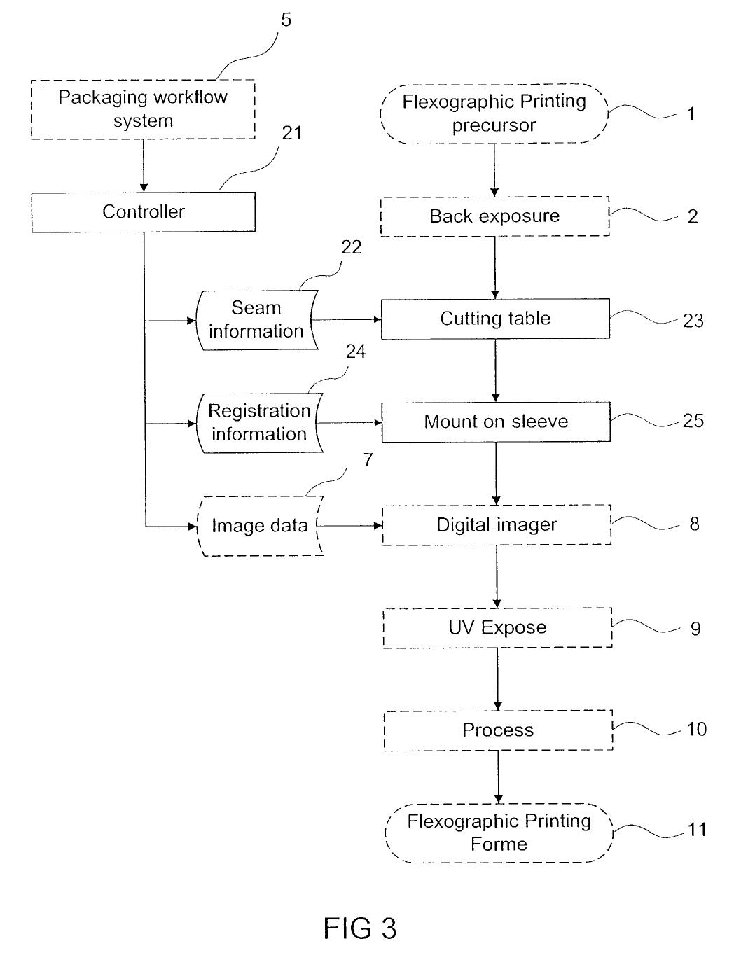

FIG. 3 is a flowchart which illustrates a preferred embodiment of this invention. This invention provides automatic methods and apparatus for producing flexographic printing sleeves. The items drawn in broken lines in FIG. 3 are not directly applicable to the present invention but are included to show the context of the methods of the present invention in the overall process of making a flexographic printing forme.

Throughout this description and the following claims:

“flexographic printing precursor” means a layer of material that may be imagewise converted and processed to form a relief surface for flexographic printing (whether or not is has been imaged and/or processed);

“sleeve substrate” means a cylindrical tube of material that may be used as a base to support a flexographic printing precursor;

“flexographic printing sleeve” means a sleeve substrate with a flexographic printing precursor on it; and,

“flexographic printing forme” means a flexographic printing sleeve that has been imaged and is ready to be placed on a printing cylinder for use in a flexographic printing operation.

FIG. 3 shows a controller 21 which may comprise a software program running on a computer workstation. Controller 21 is connected via a network or some other data connection to a digital imager 8. Controller 21 facilitates the interactive arrangement of sections of flexographic printing precursor on a sleeve substrate to produce a desired seam layout for the resulting flexographic printing sleeve. Controller 21 comprises a display such as a computer workstation monitor. An operator is able to view a facsimile of the printing image on the display. Software running in controller 21 allows an operator to define a desired seam layout. The operator can use an input device, such as a mouse, light pen, trackball, touch-sensitive screen or the like to draw in seams to create an arrangement of one or more sections of flexographic printing precursor. Controller 21 may additionally be programmed with functionality to aid the operator by suggesting a seam layout calculated according to an algorithm set to minimise plate wastage or some other optimisation function. The seam layout may comprise, for example, a number of lanes or a staircase seam.

Once the seam layout has been designated, controller 21 transfers seam location information 22 to a controllable cutting device 23. Device 23 cuts the flexographic printing precursor into one or more sections according to the seam location information provided to it by controller 21. The cuts could divide the flexographic printing precursor into simple rectangular sections, could provide a staggered seam, or could provide a more complex seam.

Controller 21 may implement a packaging workflow system 5. Controller 21 may comprise any combination of one or more date processors and may be either a stand-alone device or connected together with other devices in a computer network. Information or data transfer can be accomplished in a variety of manners and this application should be understood to cover any means of file or data transfer via any form of data storage or transmission. The term “information” used in reference to seam location includes any form of data or encoding that can be used to transfer seam layout details between process steps.

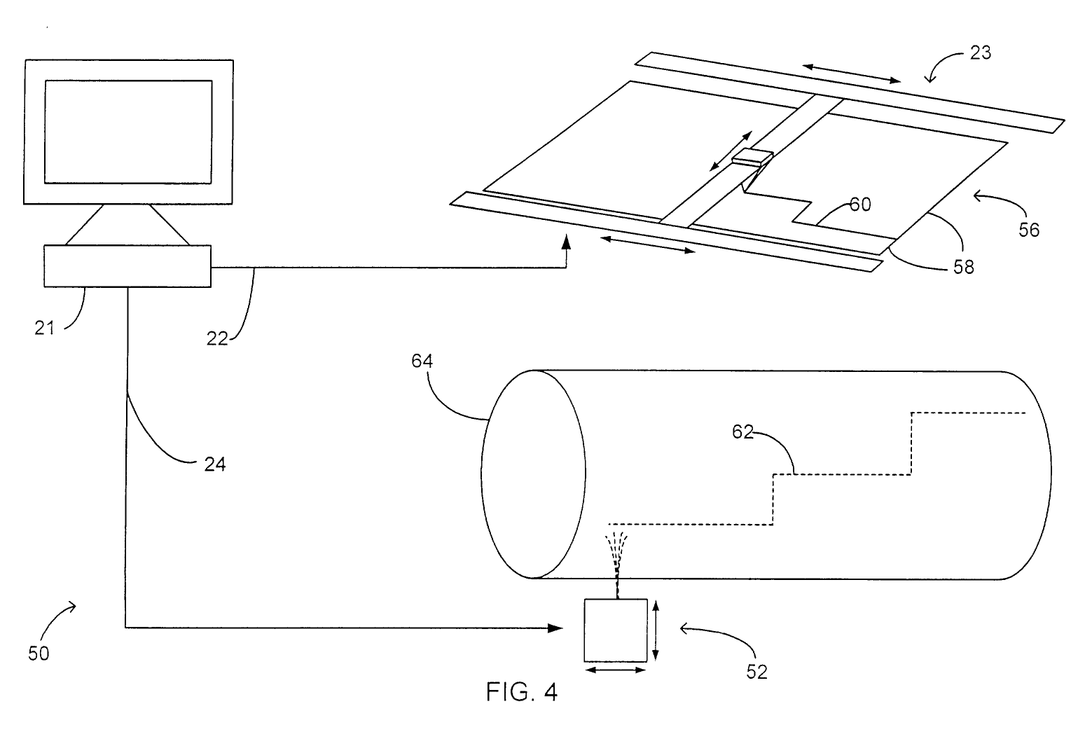

FIG. 4 schematically depicts apparatus 50 according to the invention. Apparatus 50 comprises controller 21, cutting device 23 and printing device 52. Controller 21 may comprise an interactive user interface which allows an operator (not shown) to designate an arrangement of sections of flexographic printing precursor on a sleeve substrate. Controller 21 provides seam information 22 to cutting device 23, and registration information 24 to printing device 52, based on the arrangement designated by the operator.

Cutting device 23 is configured to cut a flexographic printing precursor plate 56 into sections 58 according to seam information 22. A suitable controllable cutting device 23 is produced by Misomex International of Nashua, N.H. Misomex have a range of flatbed x-y plotting machines with cutting heads available. Such machines are capable of accurately and quickly cutting many types of material. The flexographic printing precursor can be cut with a plate protective layer intact or removed depending on the user's preference. Any cutting device capable of cutting a flexographic printing precursor in accordance with seam information 22 provided by controller 21 could be used in this invention. Cutting device 23 does not have to be a flatbed device; the plate could also be cut on a cylinder. Cutting may optionally be combined with another process such as mounting or imaging by providing a controllable cutting tool in the apparatus used to perform such other process.

Printing device 52 is configured to print registration marks 62 on sleeve substrate 64 according to registration information 24. Registration marks 62 may comprise outlines, corner placement marks, crosshair targets or any other format and may correspond to the edges of sections 58. If flexographic printing precursor plate 56 or sections 58 are imaged prior to application to sleeve substrate 64 then registration marks 62 may correspond to imaged features on sections 58. Printing device 52 may also print instructions (not shown) on sleeve substrate 64. Printing device 52 may comprise an inkjet printer head in a stand-alone machine or advantageously an inkjet printer head could be integrated into the digital imaging device 8.

Plate 56 may be imaged before it is cut into sections 58, sections 58 may be imaged after being cut but before being attached to sleeve substrate 64, or sections 58 may be imaged after being attached to sleeve substrate 64.

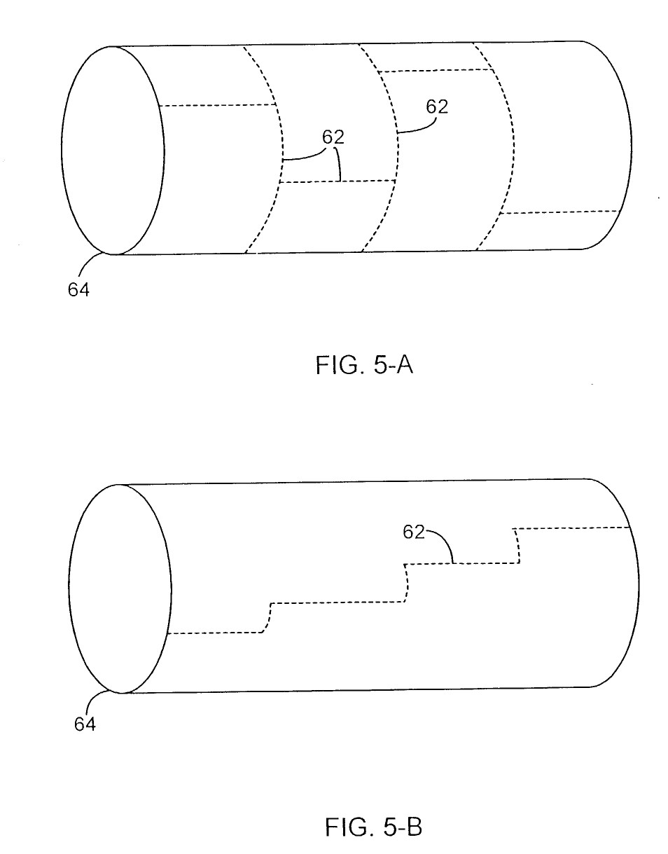

In the FIG. 4 embodiment, cutting device 23 is shown cutting a staircase seam 60, and printing device 52 shown printing staircase-shaped registration marks 62. FIG. 5-A depicts a sleeve substrate 64 with registration marks 62 printed thereon which correspond to an arrangement of sections (not shown) in lanes to produce a staggered seam. FIG. 5-B depicts a sleeve substrate 64 with registration marks 62 printed thereon which correspond to an arrangement of a single staircase-shaped section (not shown) to produce a staircase seam. It is to be understood that other seam configurations are equally within spirit and scope of the invention.

An adhesive layer may be applied to sleeve substrate 64 before registration marks 62 are printed thereon. Once the adhesive layer, which may comprise double-sided tape, is applied to the sleeve, registration marks 62 are printed onto the adhesive layer to accurately indicate the desired placement of the cut sections 58 of flexographic printing precursor. In this embodiment, printing device 52 may comprise any device capable of making marks on the adhesive layer.

Alternatively, an adhesive layer may be applied to the back or “inner surface” of the flexographic printing precursor sections 58. The term “inner surface” is used to describe a surface of section 58 which is mounted on the outer surface of sleeve substrate 64. In this case, the order of operations may change but the principles of the invention still apply. The sections 58 of flexographic printing precursor 56 can be cut with the adhesive layer on the inner surface thereof and registration marks 62 can be printed directly onto sleeve substrate 64. Such minor modifications should be understood to come within the spirit and scope of this invention.

“Adhesive layer” includes any adhesive for attaching the flexographic printing precursor sections to a sleeve substrate. The adhesive could be in tape or in sheet form, or coated, sprayed, or otherwise applied to either the outer surface of the sleeve substrate or the inner surface of the flexographic printing precursor sections.

The mounting of sections 58 with the aid of the registration marks 62 may be done on a separate mounting jig or the jig functions may be incorporated into imaging device 8. Advantageously, since the flexographic printing precursor sections 58 have been accurately cut in the automated cutting step and regulation marks 62 are accurately positioned, based on the same data used to cut the flexographic printing precursor sections 58, sections 58 can be placed properly on the sleeve substrate by aligning features of the flexographic printing precursor sections with corresponding ones of the registration marks 62.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A method for preparing a flexographic printing sleeve comprising one or more sections of flexographic printing precursor attached to a sleeve substrate, said method comprising:
providing seam layout information representing an arrangement of said one or more sections of flexographic printing precursor on said sleeve substrate;
automatically cutting a flexographic printing precursor into said one or more sections of flexographic printing precursor using a controllable cutting device responsive to said seam information; and,
attaching said one or more sections of flexographic printing precursor to said sleeve substrate in said arrangement.

2. The method of claim 1 further comprising providing registration information representing said arrangement and printing registration marks on said sleeve substrate using a printing device responsive to said registration information prior to said attaching step.

3. The method of claim 2 further comprising imaging said one or more sections of flexographic printing precursor prior to attaching said sections to said sleeve substrate.

4. The method of claim 2 further comprising imaging said one or more sections of flexographic printing precursor after attaching said sections to said sleeve substrate.

5. The method of claim 1 wherein providing said seam layout information comprises, in a programmed data processor, determining said arrangement of said one or more sections of flexographic printing precursor on said sleeve substrate by an interactive process, said interactive process comprising displaying a preview of a printing image and receiving input from an operator by way of a user interface to designate said arrangement of said one or more sections of flexographic printing precursor on said preview.

6. A method for preparing a flexographic printing sleeve comprising one or more sections of flexographic printing precursor attached to a sleeve substrate, said method comprising:
providing registration information representing an arrangement of said one or more sections of flexographic printing precursor on said sleeve substrate;
controlling a printing device to print registration marks on said sleeve substrate according to said registration information; and
attaching said one or more sections of flexographic printing precursor to said sleeve substrate according to said registration marks.

7. The method of claim 6 wherein providing said registration information comprises, in a programmed data processor, determining said arrangement of said one or more sections of flexographic printing precursor on said sleeve substrate by an interactive process, said interactive process comprising displaying a preview of a printing image and receiving input from an operator by way of a user interface to designate said arrangement of said one or more sections of flexographic printing precursor on said preview.

8. The method of claim 7 wherein providing said seam and registration information comprises, in a programmed data processor, determining said arrangement of said one or more sections of flexographic printing precursor on said sleeve substrate by an interactive process, said interactive process comprising displaying a preview of a printing image and receiving input from an operator by way of a user interface to designate said arrangement of said one or more sections of flexographic printing precursor on said preview.

9. The method of claim 8 further comprising applying an adhesive layer to an outer surface of said sleeve substrate prior to printing said registration marks.

10. The method of claim 8 further comprising applying an adhesive layer to an inner surface of said one or more sections of flexographic printing precursor prior to attaching said one or more sections of flexographic printing precursor to said sleeve substrate.

11. The method of claim 6 further comprising applying an adhesive layer to an outer surface of said sleeve substrate prior to printing said registration marks.

12. The method of claim 6 further comprising applying an adhesive layer to an inner surface of said one or more sections of flexographic printing precursor prior to attaching said one or more sections of flexographic printing precursor to said sleeve substrate.

13. An apparatus for use in preparing a flexographic printing sleeve, said flexographic printing sleeve comprising one or more sections of flexographic printing precursor attached to a sleeve substrate, the apparatus comprising:
a cutting device operative to cut a flexographic printing precursor plate;
a printing device, operative to print registration marks on said sleeve; and,
a controller operative to provide seam information and corresponding registration information representing an arrangement of said one or more sections of flexographic printing precursor on said sleeve substrate, and to control said cutting device to cut said flexographic printing precursor plate into said one or more sections of flexographic printing precursor according to said seam information, and to control said printing device to print said registration marks on said sleeve substrate according to said registration information.

14. The apparatus of claim 13 wherein said controller comprises an interactive user interface.

15. The apparatus of claim 14 wherein said controller comprises a display configured to display a preview of a printing image and an input device operable by an operator to designate said arrangement of said one or more sections of flexographic printing precursor on said sleeve substrate.

16. The apparatus of claim 15 wherein said controller is programmed to automatically generate an optimal arrangement of said sections and to display optimal arrangement to said operator.
